(19) United States
(12) Patent Application Publication
(10) Pub. No.: US 2023/0106094 A1
(43) Pub. Date: Apr. 6, 2023

(54) ENERGY TRANSFER SYSTEM AND METHOD INCLUDING FULLY INTEGRATED SUPPLY DEVICES

(71) Applicant: Ford Global Technologies, LLC, Dearborn, MI (US)

(72) Inventors: Stuart C. Salter, White Lake, MI (US); Ryan O'Gorman, Beverly Hills, MI (US); Timothy Harris, Grosse Ile, MI (US); Peter Phung, Windsor (CA); Katherine Howard-Cone, Canton, MI (US)

(21) Appl. No.: 17/492,823

(22) Filed: Oct. 4, 2021

(51) Int. Cl. B60L 53/60; B60L 53/51; B60L 53/14

(52) U.S. Cl. CPC B60L 53/60; B60L 53/51; B60L 53/14

(57) ABSTRACT

This disclosure relates to an energy transfer system and method including fully integrated supply devices. An example system includes a supply device having a vehicle port, a converter, and an isolation transformer. The vehicle port is configured to electrically couple the supply device to an electrified vehicle.

### TECHNICAL FIELD

This disclosure relates to an energy transfer system and method including fully integrated supply devices.

### BACKGROUND

Electrified vehicles differ from conventional motor vehicles because they are selectively driven by one or more electric machines that are powered by at least one traction battery. The electric machines can propel the electrified vehicles instead of, or in combination with, an internal combustion engine. Plug-in type electrified vehicles include one or more charging interfaces for charging the traction battery pack. Plug-in type electrified vehicles are commonly charged while parked at a charging station or some other utility power source.

### SUMMARY

An energy transfer system according to an exemplary aspect of the present disclosure includes, among other things, a supply device having a vehicle port, a converter, and an isolation transformer. Further, the vehicle port configured to electrically couple the supply device to an electrified vehicle.

In a further non-limiting embodiment of the foregoing system, the supply device is a first supply device of a plurality of supply devices, and each of the plurality of supply devices includes a vehicle port, a converter, and an isolation transformer.

In a further non-limiting embodiment of any of the foregoing systems, the vehicle port of a first one of the supply devices electrically is configured to electrically couple the first supply device to a first electrified vehicle, the vehicle port of a second one of the supply devices electrically is configured to electrically couple the second supply device to a second electrified vehicle, the first electrified vehicle has a first traction battery with a first voltage, the second electrified vehicle has a second traction battery with a second voltage, and the first voltage is different than the second voltage.

In a further non-limiting embodiment of any of the foregoing systems, the first voltage is 800 Volts and the second voltage is 400 Volts.

In a further non-limiting embodiment of any of the foregoing systems, the converter is a DC-to-DC converter.

In a further non-limiting embodiment of any of the foregoing systems, each of the plurality of supply devices includes an inverter.

In a further non-limiting embodiment of any of the foregoing systems, each of the plurality of supply devices comprises a housing, and each of the housings encloses a respective converter, isolation transformer, and inverter inside the housing.

In a further non-limiting embodiment of any of the foregoing systems, the system includes a power source, and a bus electrically coupled to the power source, wherein each of the plurality of supply devices are electrically coupled to the bus in parallel with one another.

In a further non-limiting embodiment of any of the foregoing systems, the power source is one of a plurality of power sources, and each of the plurality of power sources are electrically coupled to the bus in parallel with one another.

In a further non-limiting embodiment of any of the foregoing systems, each of the plurality of supply devices includes an inverter port.

In a further non-limiting embodiment of any of the foregoing systems, the system includes an inverter, and each of the inverter ports is configured to couple the inverter.

In a further non-limiting embodiment of any of the foregoing systems, the inverter is a 3-phase inverter.

In a further non-limiting embodiment of any of the foregoing systems, each of the plurality of supply devices comprises a housing, each of the housings encloses a respective converter and isolation transformer, and the inverter is outside the housing.

In a further non-limiting embodiment of any of the foregoing systems, the system includes an AC grid power source and a first bus electrically coupled to the AC grid power source. Each of the plurality of supply devices is electrically to the first bus in parallel with one another. Further, the system includes a second bus electrically coupled to the inverter. Each of the plurality of supply devices is electrically to the second bus in parallel with one another.

In a further non-limiting embodiment of any of the foregoing systems, the supply device is configured to charge the electrified vehicle from a power source.

In a further non-limiting embodiment of any of the foregoing systems, an electrical input to the supply device is DC and an electrical output from the supply device is DC.

In a further non-limiting embodiment of any of the foregoing systems, an electrical input to the supply device is AC and an electrical output from the supply device is DC.

An energy transfer method according to an exemplary aspect of the present disclosure includes, among other things, transferring energy from a power source to a first electrified vehicle via a first supply device, and transferring energy from the power source to a second electrified vehicle via a second supply device. The first and second supply devices each include a converter and an isolation transformer.

In a further non-limiting embodiment of the foregoing method, the first and second supply devices each include an inverter.

In a further non-limiting embodiment of any of the foregoing methods, the first and second supply devices are each coupled to a common inverter.

### BRIEF DESCRIPTION OF THE DRAWINGS

FIG. 1 illustrates a highly schematic view of an energy transfer system according to an aspect of the present disclosure. In FIG. 1, a single supply device is shown.

FIG. 2 illustrates an example arrangement of three supply devices of the energy system of FIG. 1.

FIG. 3 illustrates a highly schematic view of the energy system of FIG. 1. In FIG. 3, three supply devices are shown.

FIG. 4 illustrates a highly schematic view of another energy transfer system according to an aspect of the present disclosure.

### DETAILED DESCRIPTION

This disclosure relates to an energy transfer system and method including fully integrated supply devices. An example system includes a supply device having a vehicle port, a converter, and an isolation transformer. The vehicle port is configured to electrically couple the supply device to an electrified vehicle. Because the isolation transformer is integrated into the supply device, the supply device is able to isolate other supply devices, such as those that exhibit undesired behaviors, that are connected in parallel with the supply device. Further, the supply device is connectable in parallel with other supply devices to a single charge source. Each of the supply devices is able to accommodate various different voltage architectures (e.g. 300 Volt, 400 Volt, 800 Volt, etc.) of the external storage devices and/or vehicles without requiring a reconfiguration of the hardware of the charging station. These and other benefits will be appreciated from the below description.

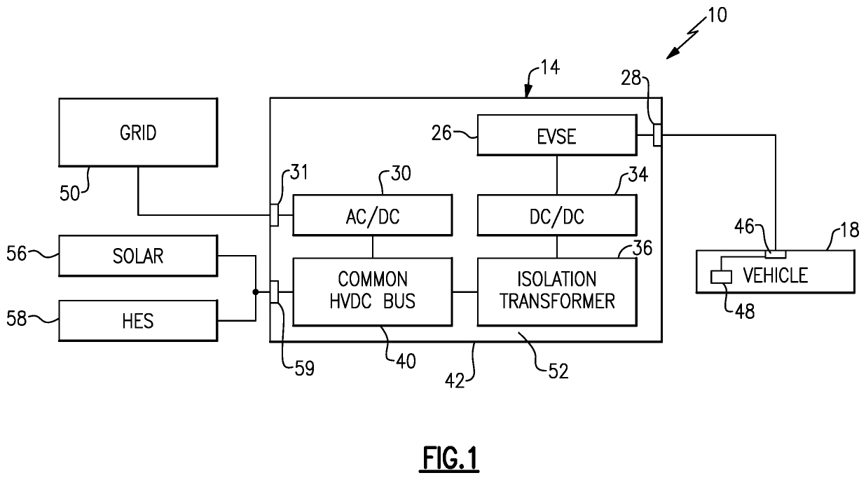

Turning to the drawings, FIG. 1 shows an exemplary energy transfer system 10 (hereinafter “system 10”) for transferring energy. The system 10, in the exemplary embodiment, includes a supply device 14 that can electrically couple an electrified vehicle 18 to a power source. The exemplary supply device 14 includes electric vehicle supply equipment (EVSE) 26 which, in this example, includes a vehicle port 28. The EVSE 26 could alternatively or additionally include a charger including a cable and plug configured to couple to a post of an electrified vehicle. The supply device 14 further includes an inverter 30, a converter 34, an isolation transformer 36, a high-voltage direct current (HVDC) bus 40, and a housing 42. The housing 42 contains and encloses the EVSE 26, the inverter 30, the converter 34, the isolation transformer 36, and the HVDC bus 40 within an interior 52 of the housing 42. In addition the aforementioned components, the supply device 14 further includes one or more transceivers and controllers, which include hardware and software configured to receive information from other components in the system 10 and further configured to issue commands to other components in the system 10.

The supply device 14 can communicate with one or more of the components of the system 10, including other supply devices, via wired/CAN/Ethernet communications, Wi-Fi (readily available), Bluetooth/BLE, wireless ad hoc networks over Wi-Fi, wireless mesh networks, low power long-range wireless (LoRa), ZigBee (low power, low data rate wireless).

A controller of the supply device 14 can be used to communicate input/output sources that are connected to the supply device 14. For example, an AC Infrastructure, portable solar array, HES, AC Non-Grid Infrastructure, etc.), connections with other electrified vehicles, 800 Volt connections (e.g. Portable Solar Arrays, BPT vehicles, Portable Storage Units, Construction Equipment, Other DC devices/vehicles etc.).

Within the housing 42, in this example the EVSE 26 is electrically connected to the converter 34, which in this example is a DC-to-DC converter configured to convert direct current from one voltage level to another. The converter 34 is electrically coupled to the isolation transformer 36. The isolation transformer 36 is electrically coupled to the HVDC bus 40, which is electrically coupled to the inverter 30.

The vehicle port 28 couples the supply device 14 to the electrified vehicle 18 such that the supply device 14 is electrically connected to the electrified vehicle 18. The vehicle port 28 can electrically connect to the electrified vehicle 18 through a charge port 46 of the electrified vehicle 18, for example. In this example, the electrified vehicle 18 has a traction battery 48 with a first voltage. In this example, the first voltage is 800 Volts. In another example, the first voltage is 400 Volts.

In an example, the supply device 14 is electrically coupled to a plurality of power sources. Specifically, the supply device 14 is electrically coupled a grid infrastructure 50 (“grid 50”), such as an AC grid infrastructure. In this example, the grid 50 is electrically coupled to the inverter 30. Further, the supply device 14 is electrically coupled to other power sources, including a solar source 56 or from a Home Energy Storage (HES) system 58, for example. In this example, the solar source 56 and the HES system 58 are electrically coupled to the HVDC bus 40.

The inverter 30 is connected to the grid 50 by an inverter port 31, in this example. Further, the solar source 56 and the HES system 58 are connected in parallel with one to the HVDC bus 40 via a port 59. The ports 28, 31, and 59 are incorporated into the housing 42 and are accessible from outside the housing 42. Ports 28, 31, and 59 may be multi-pin or multi-lug ports, such as universal multi-lug output connections.

The supply device 14 can convey electrical energy to or from the electrified vehicle 18. Specifically, the supply device 14 can be used to charge the traction battery 48 of the electrified vehicle 18. For example, the supply device 14 can recharge the traction battery 48 from the grid 50, the solar source 56, and/or the HES system 58.

The isolation transformer 36 is part of the supply device 14, and is independent of the inverter 30 and converter 34. The isolation transformer 36, in this example, can receive the output voltage from the converter 34 and provide the output voltage to the inverter 30. The isolation transformer 36 can help to protect against voltage spikes and can facilitate system control including by providing a floating ground instead of common earth ground potential. This can help to maintain voltage at a nominally constant level during energy transfer. In this example, the input voltage received by the supply device 14 is AC or DC and the output voltage is DC.

While only a single supply device 14 is illustrated in FIG. 1, a plurality of similarly-configured, or identically-configured, supply devices can be connected in parallel and used to transfer energy from one of the power sources 50, 56, 58 to a plurality of energy storage devices and/or electrified vehicles.

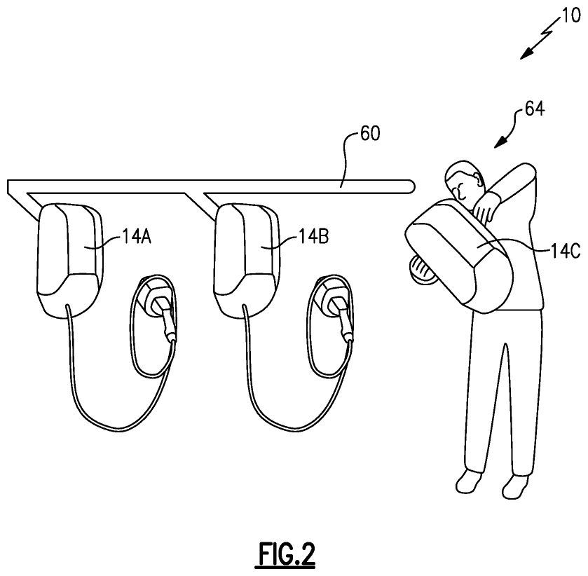

FIG. 2 illustrates an example charging station 64 including plurality of supply devices 14A-14C connectable to a bus 60 in parallel with one another. Each of the supply devices 14A-14C is configured in the same manner is the supply device 14 of FIG. 1. While only three supply devices 14A-14C are shown in FIG. 2, it should be understood that one or more supply devices 14A-14C are connectable to one or more power sources, such as the grid 50, solar source 56, and/or the HES system 58, via the bus 60. Because each of the supply devices 14A-14C contains EVSE 26, an inverter 30, a converter 34, an isolation transformer 36, and an HVDC bus 40, the supply devices 14A-14C are readily connectable the power sources via the bus 60 without requiring a reconfiguration of the hardware of charging station 64.

In FIG. 2, a worker is connecting the supply device 14C to the bus 60. In an example, the worker connects the supply device 14C by connecting one or more leads from the bus 60 into the ports 31, 59. In this regard, the supply devices 14A-14C may be considered plug and play devices.

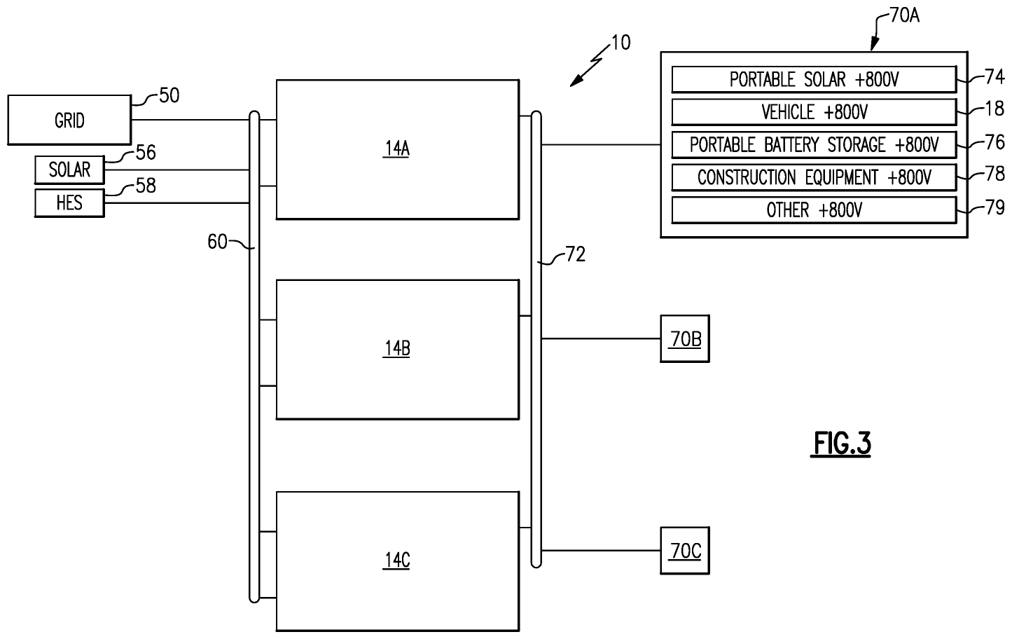

In FIG. 3, the supply devices 14A-14C are shown, schematically, connected to the power sources 50, 56, 58 via the bus 60. In this example, again, there are three supply devices 14A-14C. There are also three energy storage devices 70A-70C. The energy storage devices 70A-70C are connected to the supply devices 14A-14C in parallel via a bus 72. In an example, the bus 72 electrically connects the ports 28 in parallel. In another example there is no bus 72 and one of the supply devices 14A-14C is connected to a corresponding one of the energy storage devices 70A-70C.

The energy storage devices 70A-70C may have different charging architectures and may be provided by different types of energy storage devices. With reference to the energy storage device 70A, the energy storage device 70A may be an electrified vehicle such as the electrified vehicle 18, an 800 Volt portable solar 74, 800 Volt portable battery storage 76, 800 Volt construction equipment 78, or other electrical assemblies 79. The energy storage devices 70A-70C may also be provided by an electrified vehicle with a different voltage, such as 400 Volts, than the electrified vehicle 18. The energy storage devices 70A-70C may be provided by one of the example energy storage devices listed as an example storage device relative to energy storage device 70A. The energy storage devices 70A-70C may each be different types of energy storage devices. For instance, energy storage device 70A may be an 800 Volt electrified vehicle, energy storage device 70B may be a 400 Volt electrified vehicle, and energy storage device 70C may be an 800 Volt construction equipment.

In an example, each of the supply devices 14A-14C are capable of acting as clients or servers, and are able to command each of the other supply devices 14A-14C to be configured in a particular manner in order to facilitate a particular transfer of energy from the power sources 50, 56, 58 to the energy storage devices 70A-70C. In this regard, each of the supply devices 14A-14C are considered “smart” devices and are able to send and receive information pertaining to the operation of the energy transfer system 10.

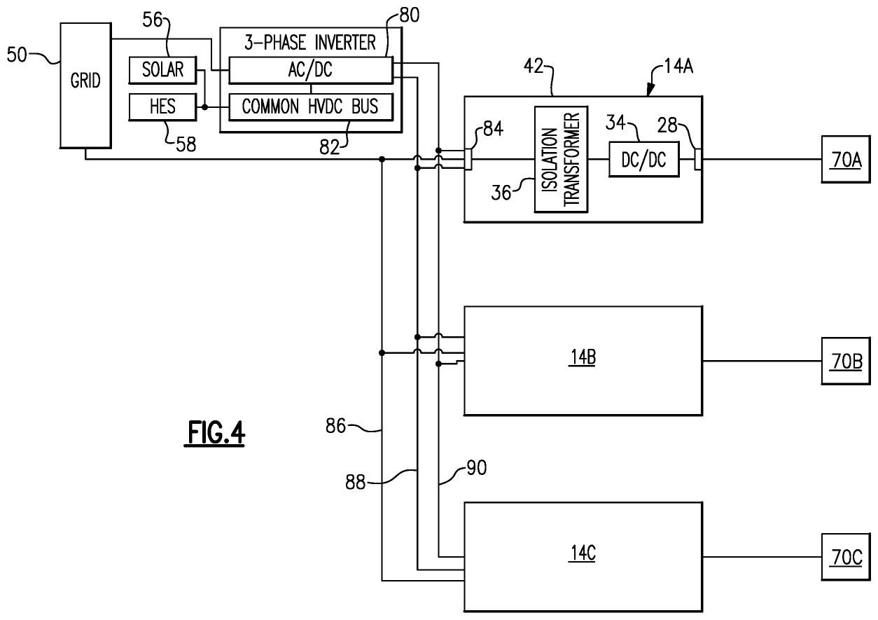

While each of the supply devices 14A-14C in FIGS. 1-3 includes an inverter 30, the supply devices 14A-14C could be connected to a common inverter 80, as shown in FIG. 4. The inverter 80 is a 3-phase inverter in this example. In addition to a common inverter 80, the supply devices 14A-14C also do not include individual HVDC buses in this example, and are instead connected to a common, shared HVDC bus 82. The inverter 80 does not need to be a 3-phase inverter and extends to other types of inverters. The inverter 80 is electrically coupled to the grid 50. The HVDC bus is electrically coupled the solar source 56 and the HES system 58.

The arrangement of FIG. 4 is particularly useful in “fleet” applications in which each of the energy storage devices 70A-70C exhibit the same architecture, such as in an application in which each of the energy storage devices 70A-70C are the same type of battery electric vehicles, such as trucks for shipping goods, for example.

The supply devices 14A-14C, in this example, are connected in parallel relative to one another, directly to the inverter 80 and also with the grid 50. For instance, if an AC output to the energy storage devices is desired 70A-70C, the direct connection to the grid 50 can be utilized.

In the embodiment of FIG. 4, the inverter 80 is a server and one or more of the supply devices 14 are clients. Specifically, the supply devices 14 are able to communicate the needs of the energy storage devices 70A-70C to the inverter 80 such that the inverter 80 functions according to those needs. In this way, the inverter 80 is able to supply dynamic, as opposed to static, power to the energy storage devices 70A-70C based on the needs of the particular energy storage devices 70A-70C. In an example “fleet” application, if a state of charge (SOC) of one electric vehicle, namely energy storage device 70A, is relatively low, and one electric vehicle, namely energy storage device 70B, is relatively high, then the supply devices 14A, 14B and inverter 80 could be configured to push energy from energy storage device 70B to energy storage device 70A and/or to prioritize transfer of energy from the inverter 70 to the energy storage device with a lower SOC.

In the embodiment of FIG. 4, with respect to the supply device 14A, the housing 42 contains and encloses a converter 34 and an isolation transformer 36 within an interior 52 of the housing 42. A port 28 is formed in the housing 42 and is configured to electrically couple the converter 34 to the energy storage device 70A. Another port 84 is formed in the housing 42 and is configured to electrically couple the isolation transformer 36 to multiple busbars, including busbar 86 electrically coupling the supply devices 14A-14C to the grid 50 in parallel with one another, busbar 88, which provides a communication protocol, and electrically couples the supply devices 14A-14C to the inverter 80, and busbar 90 which is an HVDC bus electrically coupling the supply devices 14A-14C to the inverter 80. The inverter 80 is outside the housing 42 in the embodiment of FIG. 4.

Since the port 84 connects to the inverter 80, it may be referred to as an inverter port. However, the port 84 may connect to other components. In this regard, the port 84 may be a multi-lug or multi-pin port, such as a universal multi-lug output connection. Relative to the port 28, it may also be a multi-lug or multi-pin port, and connects directly to energy storage device 70A without a bus in this example. It should be understood that supply devices 14B, 14C are arranged substantially similar to, and in one example identical to, supply device 14A.

It should be understood that terms such as “substantially” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An energy transfer system, comprising:
a supply device having a vehicle port, a converter, and an isolation transformer, the vehicle port configured to electrically couple the supply device to an electrified vehicle.

2. The energy transfer system as recited in claim 1, wherein:
the supply device is a first supply device of a plurality of supply devices, and
each of the plurality of supply devices includes a vehicle port, a converter, and an isolation transformer.

3. The energy transfer system as recited in claim 2, wherein:
the vehicle port of a first one of the supply devices electrically is configured to electrically couple the first supply device to a first electrified vehicle,
the vehicle port of a second one of the supply devices electrically is configured to electrically couple the second supply device to a second electrified vehicle,
the first electrified vehicle has a first traction battery with a first voltage,
the second electrified vehicle has a second traction battery with a second voltage, and
the first voltage is different than the second voltage.

4. The energy transfer system as recited in claim 3, wherein the first voltage is 800 Volts and the second voltage is 400 Volts.

5. The energy transfer system as recited in claim 2, wherein the converter is a DC-to-DC converter.

6. The energy transfer system as recited in claim 5, wherein each of the plurality of supply devices includes an inverter.

7. The energy transfer system as recited in claim 6, wherein:
each of the plurality of supply devices comprises a housing, and
each of the housings encloses a respective converter, isolation transformer, and inverter inside the housing.

8. The energy transfer system as recited in claim 7, further comprising:
a power source; and
a bus electrically coupled to the power source, wherein each of the plurality of supply devices are electrically coupled to the bus in parallel with one another.

9. The energy transfer system as recited in claim 8, wherein:
the power source is one of a plurality of power sources,
each of the plurality of power sources are electrically coupled to the bus in parallel with one another.

10. The energy transfer system as recited in claim 2, wherein each of the plurality of supply devices includes an inverter port.

11. The energy transfer system as recited in claim 10, further comprising an inverter, and wherein each of the inverter ports is configured to couple the inverter.

12. The energy transfer system as recited in claim 11, wherein the inverter is a 3-phase inverter.

13. The energy transfer system as recited in claim 11, wherein:
each of the plurality of supply devices comprises a housing,
each of the housings encloses a respective converter and isolation transformer, and
the inverter is outside the housing.

14. The energy transfer system as recited in claim 13, further comprising:
an AC grid power source;
a first bus electrically coupled to the AC grid power source, wherein each of the plurality of supply devices is electrically to the first bus in parallel with one another; and
a second bus electrically coupled to the inverter, wherein each of the plurality of supply devices is electrically to the second bus in parallel with one another.

15. The energy transfer system as recited in claim 1, wherein the supply device is configured to charge the electrified vehicle from a power source.

16. The energy transfer system as recited in claim 1, wherein an electrical input to the supply device is DC and an electrical output from the supply device is DC.

17. The energy transfer system as recited in claim 1, wherein an electrical input to the supply device is AC and an electrical output from the supply device is DC.

18. An energy transfer method, comprising:
transferring energy from a power source to a first electrified vehicle via a first supply device; and
transferring energy from the power source to a second electrified vehicle via a second supply device, wherein the first and second supply devices each include a converter and an isolation transformer.

19. The energy transfer method as recited in claim 18, wherein the first and second supply devices each include an inverter.

20. The energy transfer method as recited in claim 18, wherein the first and second supply devices are each coupled to a common inverter.
